(19) United States
(12) Patent Application Publication
(10) Pub. No.: US 2017/0361747 A1
(43) Pub. Date: Dec. 21, 2017

(54) PORTABLE LUMBAR SUPPORT APPARATUS

(71) Applicant: Dion Heffran, Burlingame, CA (US)

(72) Inventor: Dion Heffran, Burlingame, CA (US)

(21) Appl. No.: 15/186,456

(22) Filed: Jun. 18, 2016

(51) Int. Cl. B60N 2/66; A47C 7/46

(52) U.S. Cl. CPC B60N 2/666; B60N 2/663; A47C 7/46

(57) ABSTRACT

A portable lumbar support apparatus comprising a fabric panel removably mountable on to a backrest of a seat. The fabric panel comprises at least one vertical patch of loop fastener attached onto a front face. The apparatus further comprises a pillow comprising at least one patch of hook fastener removably attachable to the loop fastener of the fabric panel at different heights to support lumbar region in a seated position. The height of the pillow is adjustable for different users by attaching the pillow at different position along the vertical patch of the fabric panel.

### BACKGROUND OF THE INVENTION

### 1. Field of the invention

The present disclosure relates generally to lumbar support apparatuses. More specifically, the disclosure relates to portable lumbar supporting apparatus attachable to a seat and lumbar support apparatus adjustable based on user preferences and comfort.

### 2. Description of Related Art

Increased number of people are getting affected with a variety of back problems relating to musculo-skeletal disorders. Among which, lower back pain is considered to be a serious problem related to the vertebral column, which is primarily caused due to poor sitting posture. Majority of lower back pain related conditions arise due to sitting in a slouched posture or not maintaining a proper posture. Poor posture occurs more readily when the seat or chair does not give proper support to the lower back region.

The position in which the spine is held during a seated position is crucial to prevent or exacerbate back problems. The problem of not maintaining proper spinal posture, especially during traveling may result in back pain or permanent back injury. Therefore, providing a proper lower back support while seated would alleviate lower back pain.

Generally, treatment of lower back problems requires the use of a back support device to aid in the recovery. Lumbar support devices provide adequate support to the concave portion of the spinal column when remaining in a seated position. Seats and chairs are now equipped with lumbar supports due to widespread recognition of the significance of ergonomics. Still, there exists many situations where the lumbar support is fixed to a seat or chair. These support devices takes the form of inflatable pillow, cushion pad and the like. However, conventional lumbar support is not adjustable based on user preference or anatomical features and these support cushion pads are bulk, which are not fit for carrying along while travelling.

Furthermore, lower back support devices comprises cushion material for supporting the spinal column. However, these lower back supports comprise an inflatable cushion adapted to support the entire lower back region and are not adjustable. Hence, there exists a need for a portable lumbar support device that can be adjusted selectively based on user preference and comfort.

### SUMMARY OF THE INVENTION

The present invention relates to a portable lumbar support apparatus comprising a fabric panel removably mountable on to a backrest of a seat. The fabric panel comprises at least one vertical patch of loop fastener attached onto a front face. The portable lumbar support apparatus further comprises a pillow comprising at least one patch of hook fastener removably attachable to the loop fastener of the fabric panel at different heights to support lumbar region in a seated position. The height of the pillow is adjustable for different users by attaching the pillow at different position along the vertical patch of loop fastener present on the fabric panel.

In an embodiment, the fabric panel of the portable lumbar support apparatus comprises a fastening member for easy and quick mounting on to the backrest of a vehicle seat. The fabric panel may comprise a thin cushion pad enclosed within a soft fabric cover for providing added comfort to users. The pillow comprises a closed cell foam material in different shapes and the closed cell foam material is enclosed within a pillow cover. The hook fasteners are attached to the rear portion of the pillow cover.

In an embodiment, the fabric panel may comprise two narrow patches of loop fastener extending vertically along substantial portion of the fabric panel. The pillow comprises two patches of hook fasteners spaced apart in such a way so that it matches with the positioning of loop fastener patches. The height of the pillow is adjustable by attaching the pillow at different position along the vertical patch of loop fastener present on the fabric panel. Users can adjust the position of the pillow according to their body structure by easily unfastening and fastening the pillow onto the fabric panel.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DIFFERENT VIEWS OF DRAWINGS

FIG. 1 is a front view of the portable lumbar support apparatus.

FIG. 2 is a perspective view of the portable lumbar support apparatus mounted on a vehicle seat.

### DETAILED DESCRIPTION OF DIFFERENT EMBODIMENTS

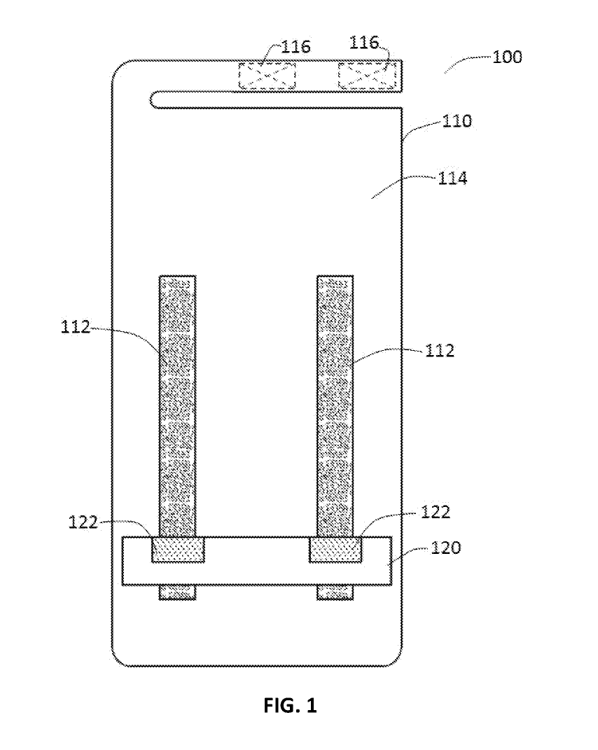

Referring to FIG. 1, showing a front view of the portable lumbar support apparatus 100 according to an embodiment. The portable lumbar support apparatus 100 comprises a holder panel 110 made of soft fabric removably mountable on to a backrest of a seat. The fabric panel 110 comprises one or more narrow vertically extending patches of loop fastener member 112 attached onto a front face 114. The portable lumbar support apparatus 100 further comprises a support pillow 120 comprising one or more patches of hook fastener member 122 configured to removably attach to the loop fastener member 112 of the fabric panel 110 at different heights to support lumbar region of a user in a seated position. The fabric panel 110 may comprise a thin cushion pad enclosed within a soft fabric cover for providing added comfort to users. The height of the pillow 120 is adjustable by attaching the pillow 120 at different position along the vertical patch of loop fastener 112 present on the fabric panel 110. The fabric panel 110 of the portable lumbar support apparatus 100 comprises a pair of complementary fastening members 116 for easy and quick mounting on to the backrest of vehicle seat.

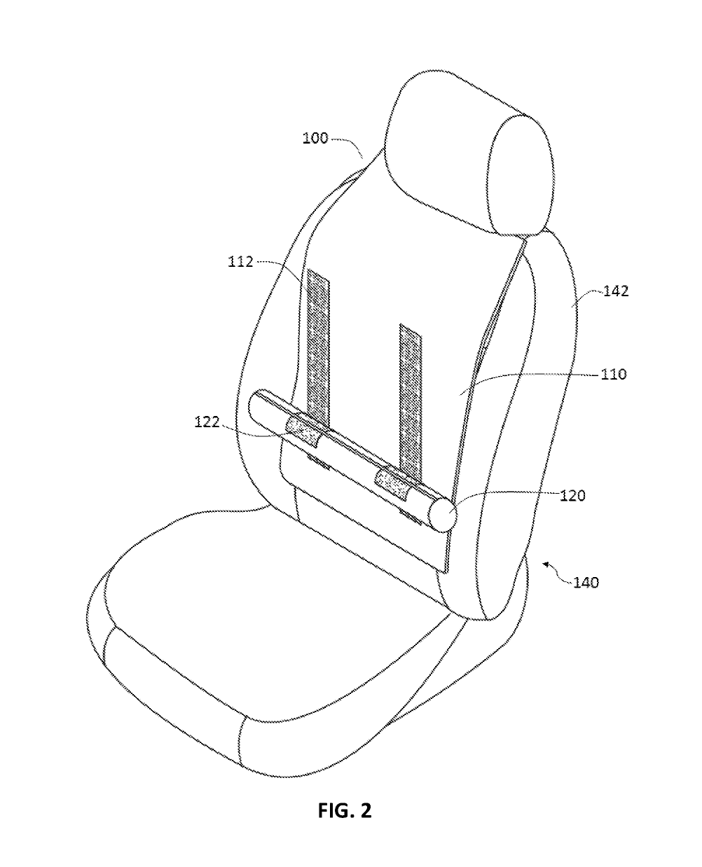

FIG. 2 shows a perspective view of the portable lumbar support apparatus 100 mounted onto a backrest 142 of a vehicle seat 140. The seat 140 can be a seating apparatus with a backrest portion such as a chair, recliner or a vehicle seat. The pillow 120 can be removably attached to the fabric panel and can be positioned anywhere along the vertical patch of loop fastener 112. The hook fasteners 122 attached to the rear portion of the pillow facilitates in attachment of the pillow 120 to the loop fastener 112 of the fabric panel 110.

The pillow 120 comprises a closed cell foam material in different shapes and the closed cell foam material is enclosed within the pillow cover. The pillow material inside the cover can be replaced, added or removed via a closure. In another embodiment, the pillow 120 may comprise inflatable chamber, cushion or bedding material. In an exemplary embodiment, the pillow 120 may comprise a cylindrical pillow or lumbar pillow.

In an exemplary embodiment, the fabric panel 110 may comprise two narrow patches of loop fastener 112 extending vertically along substantial portion of the fabric panel 110. The pillow 120 comprises two patches of hook fasteners 122 spaced apart in such a way so that it matches with the positioning of loop fastener patches 112. The height of the pillow 120 is adjustable by attaching the pillow 120 at different position along the vertical patch of loop fastener 112 present on the fabric panel 110. Users can adjust the position of the pillow 120 according to their body structure by easily unfastening and fastening the pillow 120 onto the fabric panel 110.

In one embodiment, the fastening member 116 may comprise hook and loop type fastener, sold under tradename VELCRO. In another embodiment, the fastening members 116 may comprise snap fit fastener, loop fastener, strap or buckle type fastener. The pillow 120 is positioned to rest against the lower back region of a user in a seated position. In an embodiment, the fabric panel 110 is rectangular with a dimension of 12″×28″. The pillow 120 may comprise a square, rectangular, or cylindrical structure.

The apparatus 100 can be easily carried along during traveling. The apparatus can be quickly installed and adjusted based on user preferences. When left installed in a vehicle such as a car, multiple drivers or passengers can make use of the lumbar support 100 by adjusting the pillow 120 according to their body features such as height, position of spinal curvature and the like.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A portable lumbar support apparatus comprising:
a fabric panel removably mountable on to a backrest of a seat, the fabric panel comprises at least one vertical patch of loop fastener on a front face; and
a pillow comprising at least one patch of hook fastener removably attachable to the loop fastener of the fabric panel at different heights to support lumbar region.

2. The portable lumbar support apparatus of claim 1, wherein the pillow comprises closed cell foam.

3. The portable lumbar support apparatus of claim 1, wherein the pillow comprises a cylindrical pillow.

4. The portable lumbar support apparatus of claim 1, wherein the fabric panel comprises a fastening member for removably mounting to the backrest of the seat.

5. The portable lumbar support apparatus of claim 1, wherein the pillow is removably attachable at different heights along the vertical patch of the fabric panel.

6. The portable lumbar support apparatus of claim 4, wherein the fastening member comprise a hook and loop type fastener.

7. The portable lumbar support apparatus of claim 1, wherein the pillow is positioned to rest against the lower back region of a user in a seated position.
